(19) United States
(12) Patent Application Publication
(10) Pub. No.: US 2003/0236578 A1
(43) Pub. Date: Dec. 25, 2003

(54) Data labelling apparatus and method thereof

(75) Inventors: Alex Gammerman, Egham (GB); Volodya Vovk, Egham (GB)

Correspondence Address: VOLPE AND KOENIG, P.C., UNITED PLAZA, SUITE 1600, 30 SOUTH 17TH STREET, PHILADELPHIA, PA, 19103, US

(73) Assignee: Royal Holloway University of London, Egham (GB)

(21) Appl. No.: 10/179,649

(22) Filed: Jun. 25, 2002

(51) Int. Cl. G06E 1/00; G06E 3/00; G06N 3/02; G06G 7/00; G06F 15/18; G05B 13/02

(52) U.S. Cl. 700/47

(57) ABSTRACT

The transductive confidence machine consists of data labelling apparatus which is capable of identifying for an unknown example, a range of most suitable labels from an infinite number of potential labels. The method identifies a range of possible label sets having a strangeness value below a certain pre-determined strangeness threshold, without pre-calculating the strangeness value of all of the possible label sets. The label sets each comprise training labelled examples and at least one unlabelled example, in each of the label sets each unlabelled example being associated with a different one of an infinite number of potential labels. The apparatus and method enable a mode of inference known as transductive inference, in which the labelling of every new unlabelled example is done independently. In general, no computations carried out in relation to other unlabelled examples can be re-used when a different unlabelled example is to be assigned a range of labels which are members of label sets having a strangeness value below the threshold strangeness value.

### BACKGROUND OF THE INVENTION

1. Field of the Invention

The present invention relates to data labelling apparatus and to a method thereof that is capable of identifying for an unknown example a range of most suitable labels and that additionally may provide a measure of confidence in the range identified.

In the context of this document it is to be understood that data labelling is intended as reference to the labelling of new, unlabelled, examples for which there may be a large number, often an infinite range, of potential labels. This is in contrast to data classification which is usually concerned with a very limited number, often only two, potential classifications.

A practical example of data labelling is in the assessment of house values. The range of possible values for the building is infinite. In practice, the actual range of likely values is much smaller and is dependent on such factors as number of bedrooms, location, state of repair etc. Using the data labelling technique described herein a range of potential values for an individual house can be generated automatically avoiding the subjective assessment usually involved in such valuations. Another practical example is in optimising the operating characteristics of a complex in-line manufacturing process.

2. Description of the Related Art

Learning machines that have already been developed to perform data labelling include Support Vector machines (described in V N Vapnik, Statistical Learning Theory, New York: Wiley, 1998) and Ridge Regression machines. A paper describing a learning machine employing Ridge Regression in data labelling may be found in Machine Learning, Proceedings of the Fifteenth International Conference, pp. 515-521 entitled “Ridge Regression Learning Algorithm in Dual Variables”, C Saunders, A Gammerman and V Vovk. Some of these known machines perform very well in a wide range of applications and do not require any parametric statistical assumptions about the source of the data (unlike traditional statistical procedures); the only assumption is that the examples are generated from the same distribution independently of one another—the iid assumption.

A typical drawback of such machines is that the user is not provided with any measure of the accuracy of the predicted output by the learning machine. A user has to rely on the results of previous experiments with benchmark datasets, with the hope that for the user's particular dataset similar results will be obtained. Other options for the user who wants to associate a measure of accuracy with new unlabelled examples include performing experiments on a validation set, using one of the known cross-validation procedures, and applying one of the theoretical results, which are usually very crude, about the future performance of different learning machines given their past performance. None of the known accuracy estimation procedures provide any practicable means for directly assessing the accuracy of a predicted ‘real-world’ label for an individual new example in practical machine-learning problems.

Interval estimation, which addresses the problem of accuracy in a rigorous way, is a well-studied area of both parametric and non-parametric statistics. Typically, in statistics one is interested in intervals containing the true values of the parameter (or some component of the parameter in the semi-parametric setting). In traditional statistics, however, no closed-form formulas are derived in the general non-parametric case and only low-dimensional problems can be dealt with.

International patent application publication number WO 00/28473 describes a data classification apparatus, which classifies new examples and provides a measure of confidence for each classification identified. The classification apparatus assigns individual strangeness values to each and every possible classification set comprising classified training examples and an unclassified example. The strangeness values for each classification set are compared, to identify the classification set containing the most likely potential classification for the unclassified example. However, this system is not suitable for the case where there are very large numbers of classification sets or an infinite number of possible classification sets, since the system works on the principle that individual strangeness values for all possible classification sets must be calculated before the most likely classification set can be identified.

### SUMMARY OF THE INVENTION

The present invention thus seeks to provide apparatus and a method that relies upon the Ridge Regression or another conventional technique to identify potential labels from a potentially infinite number of potential labels, for an unlabelled example and that is able to generate a valid measure of confidence for the potential labels identified.

The present invention provides data labelling apparatus comprising:

an input device for receiving

a plurality of training labelled examples, each training labelled example comprising a training set of attributes and an associated known label, and

at least one unlabelled example, each unlabelled example comprising a set of attributes for which an associated label is to be identified; and

a processor for identifying one or more potential labels for each unlabelled example,

wherein the processor includes a program memory in which is stored a set of instructions for performing analytically or computationally the following steps:

defining an infinite sample space with respect to label sets, each label set comprising the plurality of training labelled examples and the at least one unlabelled example, in each of the label sets each unlabelled example being associated with a different one of an infinite number of potential labels;

identifying a relationship between the label sets populating the infinite sample space and strangeness in which the individual label sets each have a calculable individual strangeness value; and

identifying a range of potential labels for each unlabelled example on the basis of a predetermined strangeness threshold corresponding to a maximum accepted strangeness value, the range of potential labels being members of a set of label sets having strangeness values falling within the strangeness threshold.

With the present invention a range of labels having strangeness values below a predetermined threshold, is identified. This strangeness value has a clear interpretation, in terms of the mathematical theory of probability (see the definition of lottery below) and is valid under the general iid assumption. Furthermore, the present invention is particularly suited to dealing with high dimensional problems and where there is a very large number e.g. >million labels.

The predetermined strangeness threshold reduces the number of solutions to a bounded range of solutions without first pre-calculating the strangeness values of all label sets. The present invention belongs to the mode of inference known as transductive inference, where classification of every new unlabelled example has to be done from scratch: in general, no or few computations done for other unlabelled examples can be re-used. In a first preferred embodiment, the program memory may store an optimisation algorithm for identifying the relationship between the label sets and strangeness.

The optimisation algorithm stored in the programming memory is a Ridge Regression procedure and the strangeness values generated are i-values. In alternative embodiments i-values can be replaced by p-values and the optimisation algorithm stored in the program memory may be the Aggregating Algorithm, the Nearest Neighbours algorithms etc. The data labelling apparatus may further comprise a data memory, in which the labelled and unlabelled examples may be stored. Further, the apparatus may also comprise an output terminal for outputting information concerning the range of predicted labels for the at least one unlabelled example.

The input may further include means for inputting a chosen strangeness threshold. In a further alternative the program memory may include a set of instructions for plotting a graphical representation of the relationship of strangeness values with respect to potential labels.

In a second aspect the present invention provides a data labelling method comprising the following steps that are performed analytically or computationally:

inputting a plurality of training labelled examples, each training labelled example comprising a training set of attributes and an associated known label, and inputting at least one labelled example, each unlabelled example comprising a set of attributes for which an associated label is to be identified;

defining an infinite sample space with respect to label sets, each label set comprising the plurality of training labelled examples and the at least one unlabelled example, in each of the label sets each unlabelled example being associated with a different one of an infinite number of potential labels;

identifying a relationship between the label sets populating the infinite sample space and strangeness in which the individual label sets each have a calculable individual strangeness value; and

identifying a range of potential labels for each unlabelled example on the basis of a predetermined strangeness threshold corresponding to a maximum accepted strangeness value, the range of potential labels being members of a set of label sets having strangeness values falling within the strangeness threshold.

### BRIEF DESCRIPTION OF THE DRAWINGS

An embodiment of the present invention will now be described by way of example with reference to the accompanying drawings, in which:

FIG. 1 is a schematic diagram of data labelling apparatus in accordance with the present invention;

FIG. 2 is an example of a training set and a test set for use with the present invention;

FIG. 3 is a second example of a training set and a test set for use with the present invention;

FIG. 4 is a plot of a confidence graph; and

FIG. 5 is a schematic diagram of a data labelling method in accordance with the present invention.

### DETAILED DESCRIPTION OF THE PREFERRED EMBODIMENTS

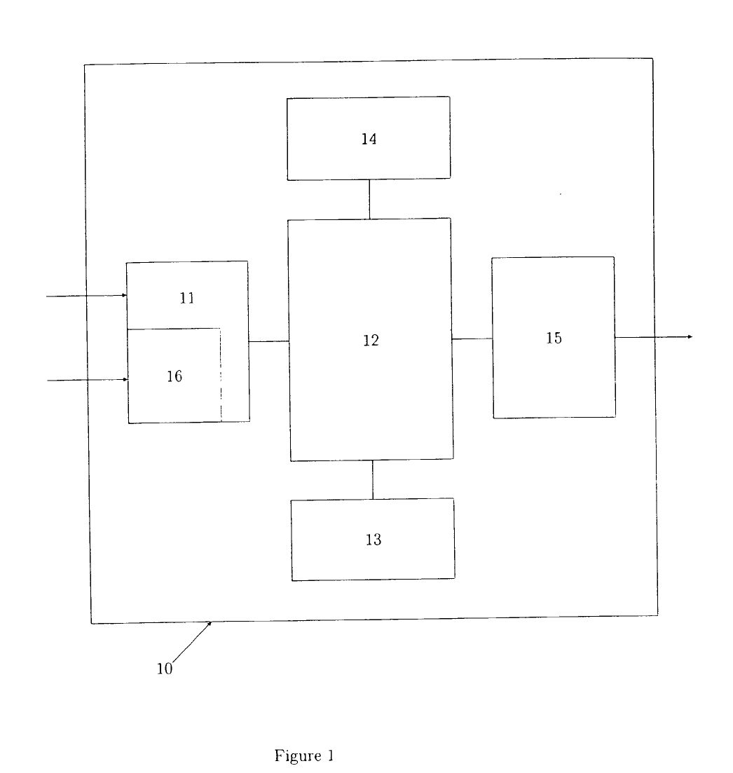

In FIG. 1 a data labeller 10 is shown generally consisting of an input device 11, a processor 12, a memory 13, a ROM 14 containing a suite of programs accessible by the processor 12 and an output terminal 15. The input device 11 preferably includes a user interface 16 such as a keyboard or other conventional means for communicating with and inputting data to the processor 12 and the output terminal 15 may be in the form of a display monitor or other conventional means for displaying information to a user. The output terminal 15 preferably includes one or more output ports for connection to a printer or other network device. The processor 12 and memories 13, 14 may be embodied in an Application Specific Integrated Circuit (ASIC) with additional RAM chips. Ideally, the ASIC would contain a fast RISC CPU with an appropriate Floating Point Unit.

To assist in an understanding of the operation of the data labeller 10 in providing a prediction of labels for unlabelled (unknown) examples, the following is an explanation of the mathematical theory underlying its operation.

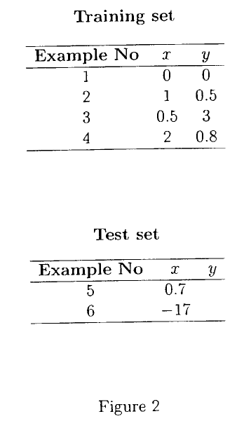

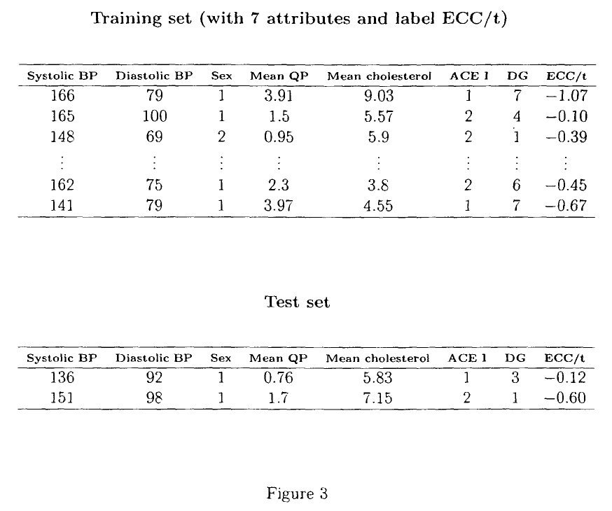

Two sets of examples (data vectors) are given: the training set that consists of examples with their labels known and a test set that consists of unlabelled examples. Therefore, each example in the training set contains an attribute vector and a label, whereas each example in the test set is identical with an attribute vector. FIGS. 2 and 3 each exemplify separate training sets and test sets. The size of the training set is given by T and for the sake of simplicity the test set is limited to one unlabelled example. Let X be the set of all possible attribute vectors (e.g. in the case of FIG. 3, X might be the Cartesian product R⁷); it is assumed that the set of all possible labels is R, the real line.

The training set consists of labelled examples (x₁,y₁), . . . (x_{T},y_{T}), where T is the number of training examples, xₜ are attribute vectors in Rⁿ (n being the number of attributes) and yₜεR, t=1, . . . , T. The goal is to predict the label y_{T+1} of the new unlabelled example x_{T+1}.

An important feature of the data labeller is the determination of strangeness values. Although the use of strangeness values is known in algorithmic information theory with respect to the deficiency of randomness, see for example “An introduction to Kolmogorov Complexity and Its Applications”, M Li and P Vitanyi, strangeness values have not previously been employed in the mathematical field of classification and labelling. The two main types of the deficiency of randomness are those proposed by Per Martin-Löf described in [“Information and Control”, 9:602-619, 1966] and by Leonid Levin [described in “On the Empirical Validity of the Bayesian Method” by V Vovk and V V'yugin, J R Statist. Soc. B, 55:253-266,1993]. However, neither of these two types is computable; an approximation has therefore been developed that is computable. The approximation is based on the notion of a randomness test and a measure of impossibility, as discussed in the papers referred to above.

In order to develop a mathematical basis for the measure of impossibility, let Ω be a sample space (a typical sample space is the set (X×R)^{T+1} of all label sets, i.e. sequences (x₁, . . . , x_{T+1}) of T+1 points in the Euclidean space xₜεRⁿ with their labels yₜεR, t=1, . . . , T+1). If P is a probability distribution in Ω, a P-measure of impossibility is defined to be a non-negative measurable function p: Ω→R such that

$${\int }_{Ω} p ( ω ) P ( ⅆ ω ) \leq 1 \qquad ( 1 )$$

This provides a notion of a ‘lottery’ in which P is a randomising device used for drawing lots and p(ω) is the value of the prize won by a particular ticket when P produces ω. With equation (1) ‘fair’ lotteries in which equation (1) is satisfied with an equality sign (i.e. lotteries in which all proceeds from selling the tickets are redistributed in the form of prizes) are not excluded. In reality, for lotteries the left-hand side of equation (1) is usually much less than 1.

By Chebyshev's inequality, p is large with small probability: for any constant C>0,

$$P \{ ω ∈ Ω : p ( ω ) \geq C \} \leq \frac{1}{C}$$

This confirms that if p is chosen in advance and P is assumed to be the true probability distribution generating the data ωεΩ, then it is unlikely p(ω) will turn out to be large. Hence, p(ω) is taken to be the strangeness value assigned to ω by p. Its inverse 1/p(ω) is called the i-value assigned to ω.

The above, though, is concerned with a single distribution P. If μ is a family of probability distributions, a μ-measure of impossibility is defined as a function which is a P-measure of impossibility for all Pεμ. For the purposes of data labelling, the P^{m}(Z)-measure of impossibility is of interest where Z is any measurable space, m is a positive integer (the sample size) and P^{m}(Z) stands for the set of all product distributions P^{m} in Z^{m}, P running over all probability distributions in Z. This definition is interpreted as follows: if p is a P^{m}(Z)-measure of impossibility and z₁, . . . , zₘ are generated independently from the same distribution (the iid assumption), it is hardly possible that p(z₁, . . . , zₘ) is large (provided p is chosen before the data z₁, . . . , zₘ are generated).

In data labelling m (the sample size) equals T+1 and Z (the measurable space) equals (X×R) such that P^{T+1}(X×R)-measures of impossibility are of interest.

In order to determine a particular P^{T+1}(X×R)-measure of impossibility, a continuum of completions is considered of the available data: (x₁,y₁), . . . , (x_{T},y_{T}),x_{T+1}. The completion y where yεY is (x₁,y₁), . . . , (x_{T},y_{T}),(x_{T+1},y) (thus in all completions every example is labelled); such completions will be called label sets. In the following explanation y is temporarily denoted as y_{T+1} for the sake of clarity. Some strangeness value must be associated with each label set (x₁,y₁), . . . , (x_{T+1},y_{T+1}). This is done by defining individual strangeness values in terms of an auxiliary optimisation problem.

For example, with every label set (x₁,y₁), . . . , (x_{T},y_{T}),(x_{T+1},y_{T+1}) is associated a Ridge Regression optimisation problem

$$a ( ω \cdot ω ) + {\sum }_{t = 1}^{T + 1} {( {y}_{t} - ω \cdot {x}_{t} )}^{2} -> min , \qquad ( 2 )$$

where a>0 is a fixed constant. There is an implicit assumption here that some linear function x [symbol] y fits the data well; later this assumption is dispensed with. The above problem is then rewritten introducing slack variables ξₜ as

$$a ( ω \cdot ω ) + ( {\sum }_{t = 1}^{T + 1} {ξ}_{t}^{2} ) -> min , \qquad ( 3 )$$

subject to the constraints

ξₜ=yₜ−((xₜ·ω)+b),t=1 , . . . , T+1 (4)

As usual in the art, this optimisation problem is transformed, via the introduction of Lagrange multipliers αₜ, t=1, . . . , T+1 to the dual problem; find αₜ from

$${\sum }_{t = 1}^{T + 1} {y}_{t} {α}_{t} - \frac{1}{4} {\sum }_{t = 1}^{T + 1} {α}_{t}^{2} - \frac{1}{4 a} \frac{1}{2} {\sum }_{t = 1}^{T + 1} {y}_{t} {y}_{s} {α}_{t} {α}_{s} ( {x}_{t} \cdot {x}_{s} ) -> max . \qquad ( 5 )$$

This particular optimisation problem can be solved explicitly providing the solution

ŷ=Y′(K+α1)⁻¹k (6)

In equation (6) the following notation is employed: Y is the vector of the first T labels,

$$( \begin{matrix}{y}_{1} \\ ⋮ \\ {y}_{T}\end{matrix} )$$

K is the T×T matrix from x₁, . . . x_{T},

K_{t,s}=xₜ·xₛ, t=1, . . . , T, s=1, . . . , T,

and k is the vector

$$( \begin{matrix}{x}_{1} \cdot {x}_{T + 1} \\ ⋮ \\ {x}_{T} \cdot {x}_{T + 1}\end{matrix} )$$

The square αₜ² of the Lagrange multiplier αₜ is taken, as the individual strangeness value of (xₜ,yₜ). This is proportional to the squared distance (measured along the y-axis) from (xₜ,yₜ) to the best Ridge Regression approximation to the label set (x₁,y₁, . . . , x_{T+1},y_{T+1}). The measure of impossibility of the label set will be defined as the individual strangeness value, properly normalised, of the last example (x_{T+1},y_{T+1}), thus as the measure of impossibility the following ratio is used:

$$\frac{{α}_{T + 1}^{2}}{\frac{1}{T + 1} {\sum }_{t = 1}^{T + 1} {α}_{t}^{2}} .$$

This results in the measure of impossibility being rewritten as:

(T+1)(y−ŷ)²/(∥(K+aI)⁻¹Y(∥x_{T+1}∥²+a−k′(K+aI)⁻¹k)+(K+aI)⁻¹k(ŷ−y)∥²+(y−ŷ)²) equation (7)

where ŷ is the Ridge Regression prediction in equation (6) of y_{T+1}. Thus, where y≈ŷ, the measure of impossibility is low whereas where y is very different from ŷ the measure of impossibility is high.

Evaluation of equation (7) can be implemented as follows:

Compute matrix B=(K+aI)⁻¹

Compute vector V=Bk

Compute vector U=BY(∥x_{T+1}∥²+a−k′V)

Compute numbers ∥U∥², U·V and ∥V∥²

Plot (as a function of z=y−ŷ) the confidence graph

$$( T + 1 ) \frac{{z}^{2}}{{‖ U - Vz ‖}^{2} + {z}^{2}} = \frac{( T + 1 ) {z}^{2}}{{‖ U ‖}^{2} - 2 ( U \cdot V ) z + ( {‖ V ‖}^{2} + 1 ) {z}^{2}} \qquad ( 8 )$$

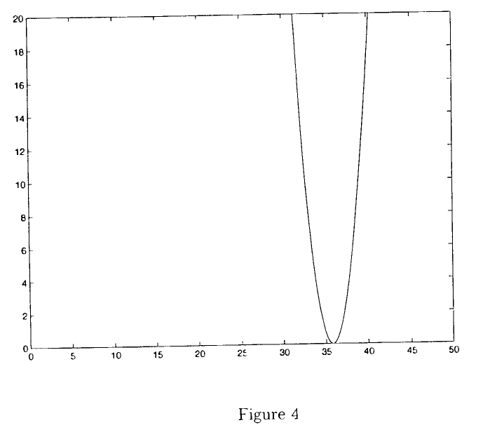

An example of such a plot is shown in FIG. 4.

A typical mode of use of this formula is that some threshold, such as 20 or 100, is chosen in advance; e.g. choosing 20 means that we regard winning £20 or more on a £1 lottery ticket unlikely. (This corresponds to choosing one of the standard significance levels such as 5% or 1% in statistics.) After this the prediction might be the smallest interval containing labels with strangeness values at most 20.

Next the linearity assumption is removed. The quadratic optimisation problem, equation (2), is applied not to the attribute vectors xt themselves, but to their images F(xₜ) under some predetermined function F:X→H taking values in Hilbert space, which leads to replacing the dot product xₜ·xₛ in the optimisation problem in equation (5) by the kernel function

κ(xₜ,xₛ)=F(xₜ)·F(xₛ).

The final expression for the confidence graph is, therefore, (7) with K and k defined using the kernel function, i.e. K defined by the matrix

Kₛₜ=K(xₛ,xₜ),s=1, . . . , T, t=1, . . . , T,

and k the vector

$$( \begin{matrix}κ ( {x}_{1} , {x}_{T + 1} \\ ⋮ \\ κ ( {x}_{T} , {x}_{T + 1}\end{matrix} )$$

With the data labelling apparatus of the present invention the following menus or choices may be offered to a user:

1. Prediction;

2. Prediction with a given threshold for the measure of impossibility;

3. Complete plot of the confidence graph.

A typical response to the user's selection of choice 1 might be “prediction: 36” which means that 36 will be the predicted output. A typical response to the selection of choice 2 might be “Predictive interval: [32,40]” which gives the smallest interval containing the labels whose strangeness value does not exceed the chosen threshold (such as 20). A typical response to the selection of choice 3 might be the confidence graph of FIG. 4 which is the complete plot of the strangeness values for all potential labels. It will be apparent that the “prediction” of choice 1 is where the minimum of the plot is obtained.

It is contemplated that some modifications of the optimisation problem set out in equations (3) and (4) might have certain advantages, for example

$$a ( ω \cdot ω ) + ( {\sum }_{t = 1}^{T + 1} {ξ}_{t} ) \to min ,$$

subject to the constraints

|yₜ−(xₜ·ω+b)|≦ε,t=1, . . . , T+1.

An alternative optimisation problem (for which a closed-form formula can be easily derived) that may be employed is provided by the Aggregating Algorithm as described in “Competitive on-line linear regression”, V. Vovk in Advances in Neural Information Processing Systems, pages 364-370, Cambridge Mass., 1998.

It is further contemplated that the data labelling apparatus will be particularly useful for predicting the labels of more than one unlabelled example using a closed-form formula for computing the strangeness values corresponding to different completions. These strangeness values can be provided not only by measures of impossibility, but also by randomness tests, which would correspond to using the statistical notion of p-values in place of i-values.

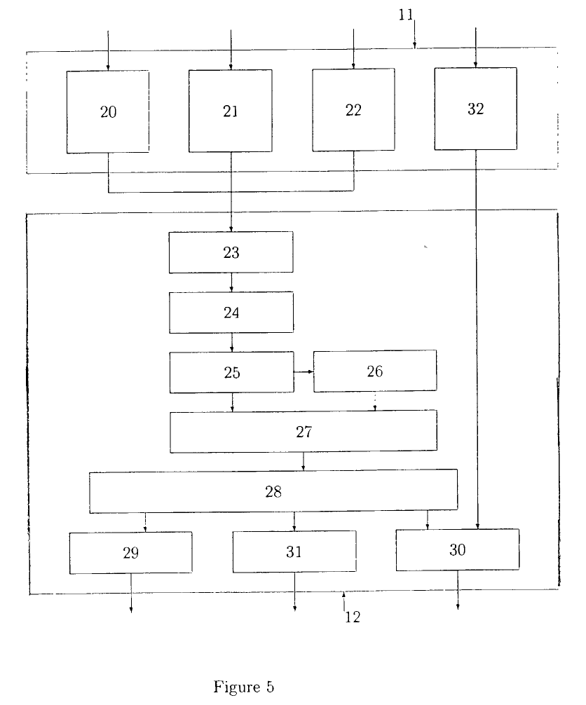

In practice, as shown in FIG. 5, a training dataset is input 20 to the data labeller. The training dataset consists of a plurality of data vectors (x₁, . . . , x_{T})each of which has an associated known label (y₁, . . . , y_{T})allocated. Some constructive representation of the measurable space of the data vectors is input 21 to the data labeller or stored in the ROM 14. For example, in the case of FIG. 3, the measurable space might be R⁷ or in the case of house prices the measurable space might consist of the number of rooms, the size of any garden, garaging and location etc. Where the measurable space is already stored in the ROM 14 of the data labeller, the interface 16 may include input means (not shown) to enable a user to input adjustments for the stored measurable space. For example, a more precise definition of a location by street or area may be needed,

One or more data vectors (x_{T+1}) for which no label is known are also input 22 into the data labeller. The training dataset and the unlabelled data vectors along with any additional information input by the user are then fed from the input device 11 to the processor 12.

Label sets are identified containing each of the labelled examples with their labels and the unlabelled examples with their provisional labels. Associated individual strangeness values are then defined by means of an optimisation algorithm such as the Ridge Regression procedure. Strangeness values are then defined for the unclassified examples from the individual strangeness values. The relationship between potential labels for each unlabelled example and their associated strangeness values is then determined and from the relationship one or more predicted labels for each unlabelled example is identified.

To do this using the Ridge Regression optimisation problem, the matrix K of the kernel function (which replaces the dot product (xₜ·xₛ)) is determined 23. Next the matrix B is determined 24 from B=(K+aI)⁻¹ and then the vector V is determined 25 from V=Bk, where k is the vector of the product of each training attribute vector with the unlabelled attribute vector. The vector U is also determined 26 using the matrix B and vector V and then values of ∥U∥², U·V and ∥V∥² are calculated 27. Finally, equation (7) is used to determine a confidence graph 28 of the measure of impossibility for the potential labels of the unlabelled data vector x_{T+1}. The minimum of the confidence graph is output 29 as the prediction for choice 1, a range of labels having less than a predetermined (or supplied 32 by the user) impossibility threshold is output 30 in response to choice 2 and a plot of the entire confidence graph is output 31 in response to choice 3. Preferably, the predetermined threshold may be stored in the ROM 14.

Although the above description of the data labelling apparatus and method uses the example of assigning values to houses it is to be understood that the data labelling apparatus and method may be used in a wide variety of useful applications, for example: estimating the life of a mechanical component i.e. the time to failure of a mechanical component. Further examples might be estimating a patient's level of renal decline before taking more expensive tests (the figures given in FIG. 3 relate to renal decline) or estimating the target company's future profits before a take-over. It is clear that confidence measures are very useful in such applications (especially in safety critical situations) e.g. a decision might be made to arrange for more expensive tests even for a patient with low estimate renal decline if the confidence in the estimate of renal decline is low.

While the data labelling apparatus and method described above has been particularly shown and described with reference to the preferred embodiment, it will be understood by those skilled in the art that various modifications in form and detail may be made therein without departing from the scope and spirit of the invention. Accordingly, modifications such as those suggested above, but not limited thereto, are to be considered within the scope of the invention.

1. Data labelling apparatus comprising:
an input device for receiving
a plurality of training labelled examples, each training labelled example comprising a training set of attributes and an associated known label, and
at least one unlabelled example, each unlabelled example comprising a set of attributes for which an associated label is to be identified; and
a processor for identifying one or more potential labels for each unlabelled example,
wherein the processor includes a program memory in which is stored a set of instructions for performing analytically or computationally the following steps:
defining an infinite sample space with respect to label sets, each label set comprising the plurality of training labelled examples and the at least one unlabelled example, in each of the label sets each unlabelled example being associated with a different one of an infinite number of potential labels;
identifying a relationship between the label sets populating the infinite sample space and strangeness in which the individual label sets each have a calculable strangeness value; and
identifying a range of potential labels for each unlabelled example on the basis of a predetermined strangeness threshold corresponding to a maximum accepted strangeness value, the range of potential labels being members of a set of label sets having strangeness values falling within the strangeness threshold.

2. Data labelling apparatus as claimed in claim 1, wherein the program memory stores an optimisation algorithm for identifying the relationship between the label sets populating the infinite sample space, and strangeness.

3. Data labelling apparatus as claimed in claim 1, further comprising a data memory for storing the labelled and unlabelled examples.

4. Data labelling apparatus as claimed in claim 1, wherein the set of instructions in the program memory identifies a range of label sets, and the relationship is used to calculate boundary values of potential labels of that range of label sets.

5. Data labelling apparatus as claimed in claim 1, further comprising an output terminal for outputting information concerning the one or more predicted labels for the at least one unlabelled example.

6. Data labelling apparatus as claimed in claim 5, wherein the output terminal outputs a range of predicted labels for the at least one unlabelled example.

7. Data labelling apparatus as claimed in claim 2, wherein the optimisation algorithm stored in the program memory is the Ridge Regression algorithm.

8. Data labelling apparatus as claimed in claim 2, wherein the optimisation algorithm stored in the program memory is a Nearest Neighbours algorithm.

9. Data labelling apparatus as claimed in claim 2, wherein the optimisation algorithm stored in the program memory is the Aggregating algorithm.

10. Data labelling apparatus as claimed in claim 2, wherein the optimisation algorithm stored in the program memory is the Support Vector Machine.

11. Data labelling apparatus as claimed in claim 2, wherein the optimisation algorithm stored in the program memory is a neural network.

12. Data labelling apparatus as claimed in claim 1, wherein the input device includes means for inputting a chosen strangeness threshold.

13. Data labelling apparatus as claimed in claim 1, wherein the program memory includes a set of instructions for outputting a graphical representation of the relationship of strangeness values with respect to potential labels.

14. Data labelling apparatus as claimed in claim 2, wherein the program memory includes a set of instructions for transforming the optimisation algorithm using Lagrange multipliers.

15. Data labelling apparatus as claimed in claim 2, wherein the program memory includes a set of instructions for applying the optimisation algorithm to images of the attribute vectors in a Hilbert Space.

16. A data labelling method comprising the following steps that are performed analytically or computationally:
inputting a plurality of training labelled examples, each training labelled example comprising a training set of attributes and an associated known label, and inputting at least one labelled example, each unlabelled example comprising a set of attributes for which an associated range of labels is to be identified;
defining an infinite sample space with respect to label sets, each label set comprising the plurality of training labelled examples and the at least one unlabelled example, in each of the label sets each unlabelled example being associated with a different one of an infinite number of potential labels;
identifying a relationship between the label sets populating the infinite sample space and strangeness in which the individual label sets each have a calculable strangeness value; and
identifying a range of potential labels for each unlabelled example on the basis of a predetermined strangeness threshold corresponding to a maximum accepted strangeness value, the range of potential labels being members of a set of label sets having strangeness values falling within the strangeness threshold.

17. A data labelling method as claimed in claim 16, wherein an optimisation algorithm stored in the program memory identifies the relationship between the label sets populating the infinite sample space, and strangeness.

18. A data labelling method as claimed in claim 17, wherein the optimisation algorithm stored in the program memory is the Ridge Regression algorithm.

19. A data labelling method as claimed in claim 17, wherein the optimisation algorithm stored in the program memory is a Nearest Neighbours algorithm.

20. A data labelling method as claimed in claim 17, wherein the optimisation algorithm stored in the program memory is the Aggregating Algorithm.

21. A data labelling method as claimed in claim 17, wherein the optimisation algorithm stored in the program memory is the Support Vector Machine.

22. A data labelling method as claimed in claim 17, wherein the optimisation algorithm stored in the program memory is a neural network.

23. A data labelling method as claimed in claim 16, wherein the set of instructions in the program memory identifies a range of label sets, and the relationship is used to calculate boundary values of potential labels of that range of label sets.

24. A data labelling method as claimed in claim 16, further comprising outputting information concerning the one or more predicted labels for the at least one unlabelled example.

25. A data labelling method as claimed in claim 24, further comprising outputting a range of predicted labels for the at least one unlabelled example.

26. A data labelling method as claimed in claim 16, further comprising inputting a chosen strangeness threshold.

27. A data labelling method as claimed in claim 16, further comprising plotting the relationship between strangeness values and potential labels.

28. A data labelling method as claimed in claim 17, wherein the optimisation algorithm is transformed using Lagrange multipliers.

29. A data labelling method as claimed in claim 17, wherein the optimisation algorithm is applied to images of the attribute vectors in a Hilbert space.
